(19) United States
(12) Patent Application Publication
(10) Pub. No.: US 2009/0151837 A1
(43) Pub. Date: Jun. 18, 2009

(54) PNEUMATIC TIRE AND CONFIGURATION FOR REDUCING A TIRE NOISE

(75) Inventor: Lutz UHLENBRUCH, Herbstein (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/338,851

(22) Filed: Dec. 18, 2008

(30) Foreign Application Priority Data
Dec. 18, 2007 (DE) 102007060866.9

(51) Int. Cl. B60C 5/00; B60C 19/00

(52) U.S. Cl. 152/450

(57) ABSTRACT

A pneumatic tire is provided for reducing a tire noise having an annular cavity and at least one acoustic damper, situated in the cavity, made of an open-celled material. The acoustic damper is removably connected to an inner face of the pneumatic tire facing toward the cavity using at least one removably connectable connection device. Furthermore, a wheel rim is provided having a pneumatic tire drawn thereon, an annular cavity being shaped between wheel rim and pneumatic tire, as well as at least one acoustic damper made of open-celled material, which is situated in the cavity, which is distinguished in that the acoustic damper is removably connected on an inner face facing toward the cavity using at least one removably connectable connection device.

### CROSS-REFERENCE TO RELATED APPLICATION

This application claims priority to German Patent Application No. 102007060866.9, filed Dec. 18, 2007, which is incorporated herein by reference in its entirety.

### TECHNICAL FIELD

The present invention generally relates to the field of tire technology and specifically relates to a pneumatic tire having an annular cavity and at least one acoustic damper made of an open-celled material situated in the cavity. Furthermore, the present invention relates to a configuration that comprises a wheel rim having a pneumatic tire drawn thereon, as well as at least one acoustic damper made of an open-celled material situated in the cavity between wheel rim and pneumatic tire.

### BACKGROUND

In modern motor vehicles, as little driving noise as possible is to enter the passenger compartment, so as to increase the driving comfort. Tubeless pneumatic tires have been proven to be problematic in this regard, because the annular tire cavity acts as a resonance chamber, in which resonant sound waves may be excited by the tire rotation and impacts because of uneven roadway surface. As experiments have shown, the sound waves generated in this case propagate in the peripheral and radial directions and have maximum amplitudes at a resonant frequency which is typically in the range of approximately 200-250 Hz.

The sound waves excited in the cavity of the pneumatic tires are transmitted in the form of structure-borne noise via the wheel suspensions and the vehicle body into the passenger compartment and may be perceived therein by the vehicle occupants as low-frequency droning noise. This droning noise is typically perceived as very annoying, but causes the additional difficulty that it encourages and/or triggers a certain tiredness or sleepiness of the driver due to its monotony.

For this reason, many efforts have already been made by the tire manufacturers and automobile companies to inhibit the generation of resonant air oscillations in the pneumatic tires. For example, the cavity of the pneumatic tires is divided by partition elements for this purpose, and influence is to be taken on the resonant frequencies of the excited air oscillations. Such a division of the tire cavity is described, for example, in European Patents EP 0737597 B1 and EP 1110763 B1.

In an alternative procedure thereto, an acoustic damper made of a material which absorbs noise, such as open-celled foam, is introduced into the cavity of the pneumatic tire, to thus decrease the amplitude of the generated resonant oscillations and interfere with their propagation. For example, the introduction of an acoustic damper into the tire cavity is described in European Patent Applications EP 1798075 A2, EP 1800911 A2, EP 1659004 A1, and EP 1795377 A2, which form the species, and in US Patent Applications US 2005/027777 A1 and US 2007/0175560 A1.

As results from an analysis of the prior art, the acoustic dampers have been permanently bonded up to this point with the wheel rim or the inner faces of the pneumatic tire using adhesive or by rubber vulcanization. Because at least one tire bead must be brought over the entire inner contour of the wheel rim when the pneumatic tire is drawn onto the wheel rim, an acoustic damper fastened to the wheel rim involves the danger that the tire bead will damage the acoustic damper during the tire mounting. In industrial mass production, the collision avoidance required for this purpose undesirably results in increased cost and time outlay.

Such a disadvantage is avoided by fastening the acoustic damper on the inner face of the pneumatic tire, but the pneumatic tire may no longer be repaired in this case upon the occurrence of minor damage, for example, upon insertion of a nail or a shard, and must be replaced. In addition, a complete replacement is also necessary if the pneumatic tire is worn out with a still functional acoustic damper or the acoustic damper is worn out with a still functional pneumatic tire.

In view of the foregoing, it is at least one object of the present invention to provide a pneumatic tire for a motor vehicle, by which the cited disadvantages may be avoided. Thus, such a pneumatic tire is to allow simple mounting without increased cost and time outlay in industrial mass production. In addition, in the event of tire damage, tire repair is to be made possible and worn acoustic dampers are to be able to be replaced easily, to be able to use the affected pneumatic tire further. Vice versa, in the event of a worn-out pneumatic tire, a still usable acoustic damper is to be able to be used further. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics, are achieved according to embodiments of the invention by a pneumatic tire and by a configuration. The embodiments include, but are not limited to a tubeless pneumatic tire for reducing a tire noise is disclosed. The pneumatic tire is provided with an approximately annular (or toroidal) cavity, in which at least one acoustic damper made of an open-celled material suitable for noise absorption is situated for the noise damping. The open-celled material of the acoustic damper is, for example, an open-celled (open-pore) foam material, such as polyurethane foam. The open-celled material of the acoustic damper may also, for example, be a fibrous material comprising fibers interlinked with one another, such as a fiber nonwoven or a fiber felt.

The pneumatic tire according to an embodiment of the invention is essentially distinguished in that the acoustic damper is removably (detachably) connected to an inner face of the pneumatic tire facing toward the annular cavity using at least one removably (reversibly) connectable connection device.

By fastening the acoustic damper on the inner face of the pneumatic tire, the pneumatic tire allows the pneumatic tire to be drawn easily onto the wheel rim, so that in industrial mass production, increased cost and time outlay during the tire mounting may be avoided. Furthermore, fastening on the pneumatic tire has the advantage that the acoustic damper is pressed against the tire by the centrifugal force generated upon tire rotation. Because of the removable fastening of the acoustic damper to the inner face of the pneumatic tire, a removal of the acoustic damper from the pneumatic tire is especially advantageously possible, for example, to repair the pneumatic tire or to replace the acoustic damper and/or the pneumatic tire (without acoustic damper). The pneumatic tire and/or acoustic damper may then be used further, by which the user may save costs.

In a preferred embodiment of the pneumatic tire, which is technically simple to implement, the connection device is implemented in the form of a hook-and-loop closure having two reversibly connectable hook-and-loop closure parts, a first hook-and-loop closure part being permanently connected to the inner face of the pneumatic tire and a second hook-and-loop closure part being permanently connected to the acoustic damper.

In a further preferred design of the pneumatic tire, the acoustic body is connected in a formfitting and/or friction-locked way to the inner face of the pneumatic tire. The connection device may be implemented for this purpose in the form of a catch (or clip) and/or clamping mechanism.

Such a catch mechanism advantageously comprises at least one first catch part, which is permanently connected to the inner face of the pneumatic tire, for example, by gluing, or rubber vulcanization, which engages through a corresponding opening of the acoustic body, as well as a second catch part, which is reversibly engageable with the first catch part. The catch mechanism especially advantageously comprises a plurality of first catch parts and associated second catch parts distributed around the circumference.

In a further preferred embodiment of the pneumatic tire, the acoustic damper is exclusively situated on the rear of a running face section of the pneumatic tire. As experiments of the applicant have shown, sound oscillations propagating in the radial direction may especially advantageously be inhibited in this way. It is advantageous in this case if the acoustic damper is implemented as strip-shaped and extends around the circumference of the pneumatic tire, a strip center (dimensioned in the vehicle transverse direction and/or on the axial direction in relation to the tire axis) of the strip-shaped acoustic damper preferably being situated centered to a radial tire central plane.

However, it is also possible for a plurality of strip-shaped acoustic dampers to be situated, which each extend in the vehicle transverse direction or axial direction and are removably connected to the pneumatic tire distributed around its circumference. The plurality of strip-shaped acoustic dampers is preferably situated exclusively on the back of the running face section of the pneumatic tire.

In particular for the above-mentioned open-celled materials of the acoustic damper, a strip width (dimensioned in the vehicle transverse direction and/or in the axial direction) of the strip-shaped acoustic damper may lie in the range from about 5 to 15 cm, for example, and may be about 10 cm, for example. A radial strip thickness may lie in the range of about 1 to 5 cm, for example, and may be about 2 cm, for example.

Furthermore, the embodiments of the invention extend to a configuration for reducing a tire noise which comprises a wheel rim having a pneumatic tire drawn thereon. An annular cavity is shaped between wheel rim and the pneumatic tire, in which at least one acoustic damper made of an open-celled material suitable for noise absorption is situated. The embodiments according to the invention is essentially distinguished in that the acoustic damper is removably (detachably) connected on an inner face facing toward the cavity using at least one removably connectable connection device.

The embodiments according to the invention especially advantageously comprises a pneumatic tire as described above, in which the acoustic damper is removably connected on an inner face of the pneumatic tire facing toward the cavity using at least one removably connectable connection device. However, it is also possible that the acoustic damper is removably connected on an inner face of the wheel rim facing toward the cavity using at least one removably connectable connection device.

### BRIEF DESCRIPTION OF THE DRAWINGS

The present invention will hereinafter be described in conjunction with the following drawing figures, wherein like numerals denote like elements, and:

FIG. 1 shows a schematic perspective sectional view of a part of a pneumatic tire according to a first exemplary embodiment of the invention; and

FIG. 2 shows a schematic perspective sectional view of a part of a pneumatic tire according to a second exemplary embodiment of the invention.

### DETAILED DESCRIPTION

The following detailed description is merely exemplary in nature and is not intended to limit application and uses. Furthermore, there is no intention to be bound by any theory presented in the preceding summary and background or the following detailed description.

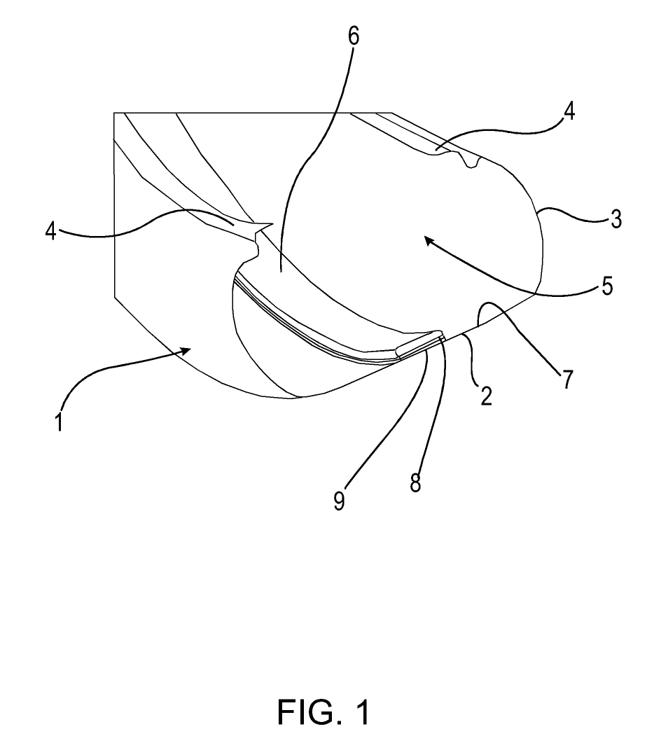

FIG. 1 is to be considered first, in which a first exemplary embodiment of the tubeless pneumatic tire for a motor vehicle wheel according to the invention is shown in a schematic perspective view. The pneumatic tire, identified as a whole by the reference numeral 1, comprises a radially external running face section 2, which is used for rolling the pneumatic tire 1 on a roadway, two side wall sections 3, and two radially internal bead sections 4, which, when the pneumatic tire is mounted on a wheel rim and subsequently filled with air, press against the wheel rim to form a seal.

The various sections 2-4 of the pneumatic tire 1 enclose an approximately annular and/or toroidal cavity 5, which extends around the circumference of the pneumatic tire 1. Upon a rotation of the mounted pneumatic tire 1 and due to impacts acting thereon as a result of roadway irregularities, resonant sound waves may be excited in the cavity 5, which propagate in the peripheral and radial directions.

A strip-shaped acoustic damper 6 is situated in the cavity 5 in the area of the radial tire central plane to reduce the amplitude of excited sound waves and to interfere with their propagation. The strip-shaped acoustic damper 6 is exclusively attached on the rear of the running face section 2 on the inner face 7 of the pneumatic tire 1 and extends annularly in the peripheral direction around the entire internal circumference of the cavity 5. The strip-shaped acoustic damper 6 is situated so that its axial strip center is located approximately at the axial height of the radial tire central plane.

The strip-shaped acoustic damper 6 comprises an open-celled foam, such as polyurethane foam, or a fibrous material comprising fibers interlinked with one another, such as a fiber nonwoven or a fiber felt. The acoustic damper 6 has an axial strip width of about 10 cm, for example, and a radial strip height of about 2 cm, for example.

The strip-shaped acoustic damper 6 is detachably fastened via a strip-shaped hook-and-loop closure made of hook-and-loop closure parts 8, 9, which are removably connectable to one another, to the inner face 7 of the pneumatic tire 1. A radially internal hook-and-loop closure part 8 is provided on its strip side facing toward the cavity 5 with an adhesive face, which is non-removably glued over its entire area to the side of the acoustic damper 6 facing toward the inner face 7. On its strip side facing away from the cavity 5, the inner hook-and-loop closure part 8 is provided with a radially internal hook-and-loop face. A radially external hook-and-loop closure part 9 is also provided on its strip side facing away from the cavity 5 with an adhesive face, which is non-removably glued over its entire area to the inner face 7 of the pneumatic tire. On its strip side facing toward the cavity 5, the external hook-and-loop closure part 9 is provided with a radially external hook-and-loop face, which is removably connectable (may be hooked) with the radially internal hook-and-loop face of the internal hook-and-loop closure part 8.

Using the hook-and-loop closure, the acoustic damper 6 may be easily fastened reversibly on the inner face 7 of the pneumatic tire 1, only the hook-and-loop faces of the two hook-and-loop closure parts 8, 9 being pressed against one another. The acoustic damper 6 may thus be removed again easily from the pneumatic tire 1 by separating the hook-and-loop faces, for example, to replace the pneumatic tire 1 or the acoustic damper 6.

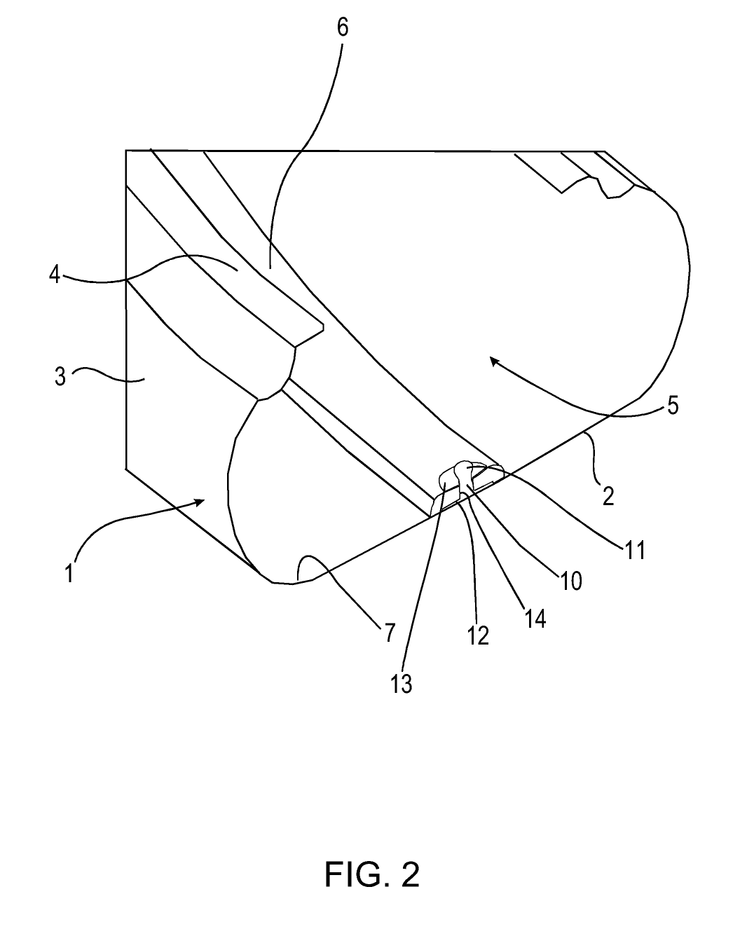

Reference is now made to FIG. 2, in which a second exemplary embodiment of the tubeless pneumatic tire for a motor vehicle wheel according to the invention is shown in a schematic perspective sectional view. To avoid unnecessary repetitions, only the differences from the exemplary embodiment shown in FIG. 1 are explained and otherwise reference is made to the statements made on FIG. 1.

The pneumatic tire 1 of FIG. 2 differs from the pneumatic tire 1 shown in FIG. 1 in the reversible and/or removable fastening of the acoustic damper 6 on the inner face 7 of the pneumatic tire 1. Instead of a hook-and-loop closure, a catch mechanism is situated, which comprises a plurality of catch pins 10, situated distributed around the circumference and directed radially inward, which are identified by the reference numeral 10. Only a single catch pin 10 is shown in FIG. 2.

The catch pins 10, which are made of plastic or rubber, for example, are each provided with a spherical thickened pin end 11 and are non-removably fastened via a flat pin base 12 on the inner face 7 of the pneumatic tire 1 using gluing or a rubber vulcanization method, for example. The catch pins 10 engage through appropriately shaped openings 14 of the acoustic damper 6, the thickened pin ends 11 engaging behind the acoustic damper 6. Spring washers 13, made of plastic, for example, which are each provided with a central hole for this purpose, are pushed onto the catch pins 10 from the spherical thickened pin ends 11. The pushed-on spring washers 13 engage behind the spherical thickened pin ends 11 and thus lock with the catch pin 10.

To fasten the acoustic damper 6 on the inner face 7 of the pneumatic tire 1, the catch pins 10 only have to be put through the openings 14 of the acoustic damper 6 and the spring washers 13 removably locked with the catch pins 10. The spring washers 13 may be drawn off the catch pins 10 in the same way, so that the acoustic damper 6 may be removed from the pneumatic tire 1, for example, to repair the pneumatic tire 1 in the event of damage of the running face section 2. After repair of the pneumatic tire 1, the acoustic damper 6 may be fastened again easily by pushing on the catch pins 10 and locking the spring washers 13.

Although this is not shown in the figures, the pneumatic tire 1 invention may be part of a configuration for reducing a tire noise, which comprises a wheel rim having a drawn-on pneumatic tire 1. An annular cavity 5 is shaped between the wheel rim and the pneumatic tire, in which an acoustic damper 6 is located, which is detachably fastened to the inner face 7 of the pneumatic tire 1.

The pneumatic tire according to an embodiment of the invention allows a reversible (detachable) fastening of the acoustic body on the inner face of the pneumatic tire using a removably connectable connection device, for example, a hook-and-loop closure or a catch and/or clip mechanism. The acoustic body may be fastened and removed easily on the inner face of the pneumatic tire in this way. Pneumatic tires without acoustic bodies may be retrofitted easily and rapidly with an acoustic body, which is detachably fastened in the pneumatic tire using the removable connection device.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A pneumatic tire, comprising:
an annular cavity; and
an acoustic damper situated in the annular cavity, said acoustic damper formed from an open-celled material,
wherein the acoustic damper is removably connected to an inner face of the pneumatic tire facing toward the annular cavity using a removable connectable connection device.

2. The pneumatic tire according to claim 1, wherein the removable connectable connection device is implemented in a form of a hook-and-loop closure comprising a first hook-and-loop closure part permanently connected to the inner face and a second hook-and-loop closure part, removably connectable to the first hook-and-loop closure part permanently connected to the acoustic damper.

3. The pneumatic tire according to claim 2, wherein the at least one of the first hook-and-loop closure part or the second hook-and-look closure part is situated substantially around an entire circumference in an internal circumference of the pneumatic tire.

4. The pneumatic tire according to claim 1, wherein the acoustic damper is connected in at least one of a formfitting or friction-locked manner to the inner face of the pneumatic tire using the removable connectable connection device.

5. The pneumatic tire according to claim 4, wherein the removable connectable connection device is designed in a form of a clamping mechanism.

6. The pneumatic tire according to claim 4, wherein the removable connectable connection device is designed in a form of a catch mechanism.

7. The pneumatic tire according to claim 6, wherein the catch mechanism comprises;
a first catch part permanently connected to the inner face of the pneumatic tire that engages through an opening of the acoustic damper; and
a second catch part lockable to the first catch part.

8. The pneumatic tire according to claim 7, further comprising a third catch part and a forth catch part.

9. The pneumatic tire according to one of claim 1, wherein the acoustic damper is exclusively situated on a rear of a running face section of the pneumatic tire.

10. The pneumatic tire according to claim 9, wherein the acoustic damper is strip-shaped.

11. The pneumatic tire according to claim 10, wherein the acoustic damper is situated around a circumference.

12. The pneumatic tire according to claim 11, wherein an axial strip center of the acoustic damper is centered to a radial tire central plane.

13. The pneumatic tire according to claim 10, wherein the acoustic damper is positioned in an axial direction.

14. The pneumatic tire according to claim 1, wherein the acoustic damper has an axial strip width in a range from about 5 cm to about 15 cm.

15. The pneumatic tire according to claim 1, wherein the acoustic damper has a radial strip thickness in a range from about 1 cm to about 5 cm.

16. The pneumatic tire according to claim 1, wherein the acoustic damper is at least partially formed of an open-celled foam material.

17. The pneumatic tire according to claim 1, wherein the acoustic damper is at least partially formed of a fibrous material.

18. An apparatus for reducing a tire noise, comprising:
a wheel rim;
a pneumatic tire drawn upon the wheel rim;
an annular cavity shaped between the wheel rim and the pneumatic tire; and
an acoustic damper formed at least partially from an open-celled material situated in the annular cavity,
wherein the acoustic damper is removably connected on an inner face facing toward the annular cavity using a removably connectable connection device.

19. The apparatus according to claim 18, wherein the acoustic damper is removably connected to the inner face of the wheel rim facing toward the annular cavity using the removably connectable connection device.
